(19) United States
(12) Patent Application Publication
(10) Pub. No.: US 2026/0089149 A1
(43) Pub. Date: Mar. 26, 2026

(54) SECURE SINGLE SIGN-ON AUTHORIZATION

(71) Applicant: Micro Focus Software Solutions India Pvt. Ltd., Bangalore (IN)

(72) Inventor: Girish Bitmandi Mutt, Bangalore (IN)

(21) Appl. No.: 18/896,593

(22) Filed: Sep. 25, 2024

(51) Int. Cl. H04L 9/40

(52) U.S. Cl. CPC H04L 63/0815

(57) ABSTRACT

Systems and methods for secure single sign-on authentication are provided. A first opening of an application by a user is detected and an application signature is generated for the application. The user is prompted to verify the application signature. Based on the user verifying the application signature, the application signature is stored as a verified application signature in association with login credentials for the user. When an application that appears to be the first application is later opened, the verified application signature is used to validate the newly opened application. If the signature of the newly opened application does not match the verified signature, this can indicate that the newly opened application is a copycat application or that the first application has been tampered with and thus providing credentials to the newly opened application represents a security risk.

### TECHNICAL FIELD

This disclosure relates to authentication for software programs. More particularly, embodiments relate to preventing loss of credentials to malicious applications.

### BACKGROUND

In large organizations, users must interact with multiple applications. The applications may have different authentication methods, requiring the users to maintain and manage different usernames and passwords for each of the numerous applications.

A single sign-on (SSO) application can ease the burden of credential management for the user by securely storing the user's credentials and automatically providing the credentials when required. In one implementation, the SSO application collects the user's credentials for an application at an initial login and provides the credentials to the application as needed. The user is thus no longer required to remember their credentials for the application beyond their initial login.

Unfortunately, malicious applications can mimic many aspects of legitimate applications, tricking the user or SSO application into providing the user's credentials to the copycat application. The stolen credentials can then be used to illegally access sensitive data or for other nefarious reasons.

Therefore, improved SSO mechanisms are desired.

### SUMMARY

Embodiments provide systems and methods for secure single sign-on authorization. Verified application signatures can be used to prevent a single sign-on process from providing credentials to an application that has potentially been tampered with or to a copycat application. Consequently, embodiments of the present disclosure can prevent theft of login credentials by malicious applications.

One aspect of the present disclosure includes a computer-implemented method for single sign-on. The method may include detecting a first application, generating a first application signature for the application, prompting the user to verify the first application signature, based on the user verifying the first application signature, storing the first application signature as a verified application signature in association with login credentials for the user and programmatically providing the login credentials to the first application for login.

The method may further include detecting a newly opened application, generating an application signature for the newly opened application, comparing the application signature for the newly opened application to the verified application signature to determine if the application signature for the newly opened application matches the verified application signature and based on a determination that the application signature for the newly opened application matches the verified application signature, programmatically providing the login credentials associated with the verified application signature to the newly opened application for login. On the other hand, if the application signature for the newly opened application does not match the verified application signature, authorization to log in to the application can be declined by the SSO application. This ensures that SSO application authorizes the login operation to the application by validating the application signature for the newly opened application with the verified application signature.

Another aspect of the present disclosure includes non-transitory, computer-readable medium storing thereon a set of computer-executable instructions for single sign-on. The set of computer-executable instructions comprises instructions for detecting a first application, generating a first application signature for the first application, prompting the user to verify the first application signature, based on the user verifying the first application signature, storing the first application signature as a verified application signature in association with login credentials for the user, and programmatically providing the credentials to the application for login.

The set of computer-executable instructions may further comprise instructions for detecting a newly opened application, generating an application signature for the newly opened application, comparing the application signature for the newly opened application to the verified application signature to determine if the application signature for the newly opened application matches the verified application signature, and based on a determination that the application signature for the newly opened application matches the verified application signature, programmatically providing the login credentials associated with the verified application signature to the newly opened application for login. The set of computer-executable instructions may further comprise instructions for declining authorization to log in to the newly opened application if the application signature for the newly opened application does not match the verified application signature.

Another aspect of the present disclosure includes a computer system with single sign-on capability, comprising a processor and memory in communication with the processor. The memory may include a plurality of applications including a single sign-on application. The single sign-on application comprises instructions for detecting a first application, generating a first application signature for the first application, prompting the user to verify the first application signature, based on the user verifying the first application signature, storing the first application signature as a verified application signature in association with login credentials for the user, and programmatically providing the login credentials associated with the verified application signature to the first application for login.

According to one embodiment, an application signature comprises one or more of the following: a checksum of the application, a tracing for dependent dynamic link libraries of the application, a registry setting for the application in the form of a GUID (Global Unique Identifier), an application specific list of dynamic link libraries loaded by the application on launch or a list of application programming interface calls made by the application during launch of the application.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1A is a diagrammatic representation of one embodiment of a computer system with single sign-on capability.

FIG. 1B is a diagrammatic representation of one embodiment of a computer system with single sign-on capability having verified an application signature.

FIG. 2 is a diagrammatic representation of one embodiment of a computer system with single sign-on capability with a newly executed application for validation.

FIG. 3 is a diagrammatic representation of one embodiment of a flow for single sign-on secure authentication.

FIG. 4A is a diagrammatic representation of another embodiment of a flow for single sign-on secure authentication in which a newly executed application is validated.

FIG. 4B is a diagrammatic representation of another embodiment of a flow for single sign-on secure authentication in which a newly executed application is not validated.

FIG. 5A and FIG. 5B are flow chart of one embodiment of a method for secure single-sign on authentication.

FIG. 6 is a diagrammatic representation of one embodiment of a computing environment.

### WRITTEN DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Embodiments of the present disclosure provide systems and methods that prevent credentials from being stolen by malicious applications. An SSO application can be used to automatically provide login credentials to applications on a computer system. When an application is initially opened, an application signature can be generated for the application. The verified application signature is stored with login credentials for the application. When what appears to be the application is opened at a later time, the newly opened application can be validated prior to the SSO application providing the login credentials to the newly opened application. According to one embodiment, a signature is generated for the newly opened application. If the signature generated for the newly opened application matches the verified signature, the newly opened application is a valid new instance of the application that was previously verified and the login credentials are provided to the newly opened application. A mismatch between the signatures, on the other hand, indicates a risk that the newly opened application is a copycat application or that the original application has been tampered with. Remedial action can then be taken, such as removing the newly opened application from the computer system.

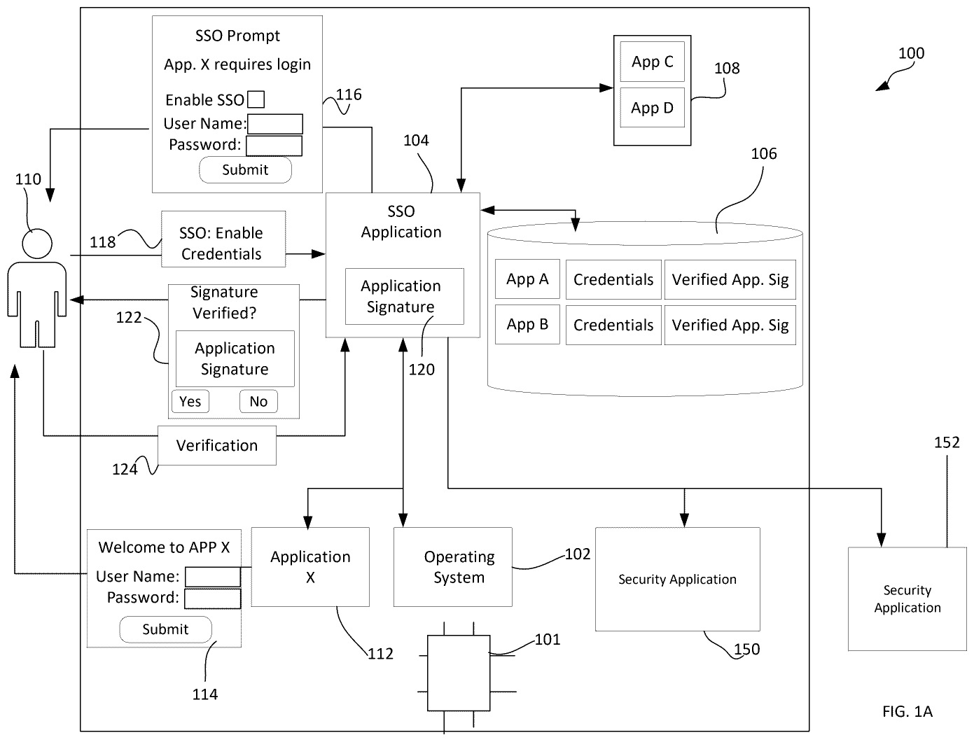

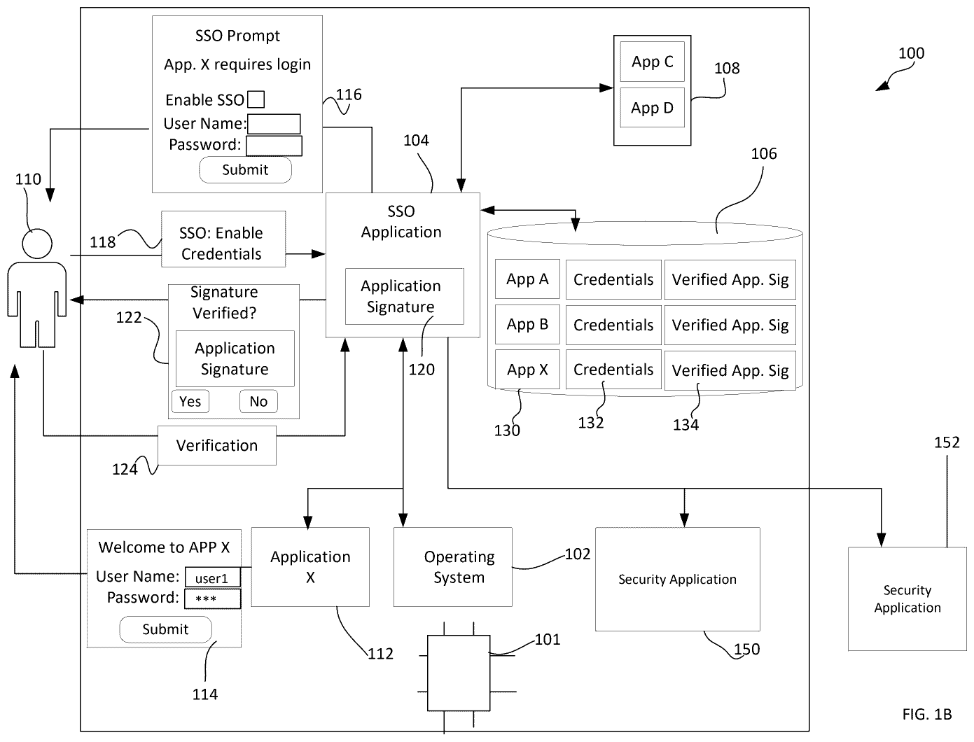

FIG. 1A and FIG. 1B are diagrammatic representations of one embodiment of a computer system 100 that comprises a number of software components that execute on a processor 101, including an operating system 102, a single sign-on (SSO) application 104 and a security application 150. In some embodiments, SSO application 104 communicates with a remote security application 152.

SSO application 104 provides SSO functionality to allow a user to login to various applications without the user having to provide their credentials at every login. In one embodiment, SSO application 104 runs in the background and provides credentials to applications as needed.

With reference to FIG. 1A, SSO application 104 maintains a secure login store 106 that stores application signatures and credentials for applications. In some embodiments, SSO application 104 also maintains a list 108 of applications for which SSO is not enabled. Applications are identified in secure login store 106 and list 108 by application identifying information, such as binary name (e.g., appa.exe, appb.exe).

SSO application 104 monitors computer system 100 for user 110 opening applications, such as application 112 (Application X). Various techniques may be used to monitor computer system 100 for the opening of an application, such as, but are not limited to, polling operating system 102 for new processes, polling operating system 102 for running processes and comparing the list of running processes returned to a prior list of running processes to identify newly started processes, setting system hooks to listen for events that indicate process creation, such as window creation events, or using event tracing features of operating system 102 to monitor for when a new process is created.

When SSO application 104 detects that application 112 has been opened, SSO application 104 determines if the newly opened application requires login. In one embodiment, for example, SSO application 104 may be programmed with a knowledgebase of applications that require login and the required credential types (e.g., username, password, PIN, etc.). Thus, the knowledgebase may be consulted to determine if the application is one that requires login.

In another embodiment, the user interface of the application is analyzed to determine if the user interface is requesting credentials. For example, application 112 may generate an application screen 114, which SSO 104 analyzes to detect inputs for credentials. Any suitable technique for recognizing requests for credentials, such as a username, password, PIN, etc. can be used. Analyzing the application screen 114 includes, in some embodiments, taking screenshots of application screen 114, recording a video stream of application screen 114, or using system APIs to capture the graphics output from application 112. According to one embodiment, SSO application 104 applies data element recognition (e.g., optical character and object recognition) to extract text and objects from application screen 114 and analyzes the extracted data elements to identify requests for credentials. For example, SSO application 104 may determine if certain labels, such as username, password, or PIN are in close proximity to (e.g., immediately above, before, or below) text input boxes.

If application 112 does not require login, user 110 can use application 112 as normal. If application 112 requires login, SSO application 104 generates a prompt to user 110 as to whether user 110 wishes to enable SSO for application 112. In the embodiment of FIG. 1A, the user interface of SSO application 104 includes an SSO prompt screen 116 with a control to allow the user to select to enable SSO for application 112. Based on user interaction with the user interface, SSO application 104 receives a response 118 indicating whether SSO should be enabled for application 112.

In some embodiments, SSO prompt screen 116 also includes fields to allow the user to enter their credentials for application 112. Thus, response 118 may also include the user credentials. In other embodiments, the credentials are collected at another point during the process, such as in signature verification screen 122 or in separate credential input screen. In any case, SSO application 104 can collect the user credentials for application 112.

If user 110 chooses not to enable SSO for application 112, SSO application 104 may execute a predefined action. In one embodiment, for example, SSO 104 adds application 112 to the list 108 of applications for which SSO is not enabled. In some embodiments, user 110 can continue to log in to application 112 as normal, without using SSO.

If user 110 indicates that SSO is to be enabled for application 112, SSO application 104 generates an application signature 120 for application 112. The application signature comprises data that remains the same over multiple openings of the application and, preferably, changes if the application is tampered with and is difficult to replicate in a copycat application. According to one embodiment, the application signature includes one or more of the following: a digital certificate of the application, a checksum of the application, dependent dynamic library extracted information, unique id of the application (e.g., application GUID), application-specific list of dynamic libraries loaded, or trace of API calls made by application 112 upon launch of the application.

As will be appreciated by those skilled in the art, operating systems typically provide various APIs and utilities that can be used to collect a large variety of information about executing applications and operating system developers and third parties provide tools to collect a wide variety of additional information. Thus, in some embodiments, SSO application 104 interacts with operating system 102 and other utilities to collect information for application signature 120. While examples below are provided primarily in the context of a Windows operating system, application certificates, dependent dynamic library information, application checksums, unique application identifiers, application specific lists of dynamic libraries and API calls made by applications can similarly be collected in other operating system environments (Windows is a trademark of Microsoft Corporation of Washington, USA) (all trademarks, service marks, tradenames and the like used herein are the property of their respective owners).

Operating systems provide tools that can be used to generate and access certificates for applications. Windows operating systems, for example, provide a number of ways to generate and access certificates of applications such as, but not limited to, SignTool, which SSO application 104 may use to generate a certificate for application 112 or collect a certificate if one already exists. Thus, collecting a digital certificate of application 112 may include, for example, interacting with the security framework of operating system 102 to access or generate a digital certificate for application 112, which may be included in application signature 120.

According to one embodiment, SSO application 104 generates a checksum of application 112, such as an SH1, MD5, SHA256, SHA384, SHA512 or other hash of application 112. Operating systems provide various APIs or tools that can be used to generate checksums of applications and, thus, in some embodiments, SSO application 104 generates the checksum by interacting with operating system 102. By way of example, but not limitations, SSO application 104 may use the certutil tool of a Windows operating system to generate a checksum of application 112. The checksum of application 112 may be included in signature 120.

SSO application 104, according to one embodiment, traces the dependent dynamic libraries (e.g., dynamic link libraries (DDLs)) of application 112. SSO application 104 may use any suitable technique to collect dependent dynamic library information. By way of example, but not limitation, SSO application 104 may use a dependency walker tool, such as Dependency Walker provided by Microsoft Corporation of Washington USA. As other nonlimiting examples, SSO application 104 can use various APIs of a Windows operating system, such as EnumProcessModules and GetModuleFileNameEx functions to enumerate all the DLLs loaded by a specific process. For example, SSO application 104 can use EnumProcessModules to get a list of all process modules loaded by application 112 and GetModuleFileNameEx to collect the file names of the DLLs. Thus, dynamic library information, such as a list of DLL filenames or other information about the DLLs loaded by application 112 may be included in the signature 120.

Windows operating systems provide APIs or tools that can be used to collect registry settings. In some embodiments, SSO application 104 collects registry settings of application 112 from operating system 102. For example, SSO application 104 collects the globally unique id (GUID) of application 112.

In some embodiments, SSO application 104 uses a process monitor of operating system 102 to collect an application-specific list of DLLs loaded by application 112. Dependency DLL tracing gives an exhaustive list of all DLLs needed by application to function effectively. This is static list that can be fetched from the operating system.

Application 112 may make various API calls to operating system 102 between when application 112 is loaded and the login prompt (e.g., application screen 114) is shown to the user. According to one embodiment, SSO application 104 traces the API calls of application 112 upon application launch. The API call information may be included in application signature 120.

Thus, application signature 120 may include a variety of information about application 112. In one embodiment, SSO application 104 provides a signature verification screen 122 in its user interface, which displays application signature 120 and includes tools to allow user 110 to verify the signature. Thus, based on user interaction with the user interface of SSO application 104, SSO application 104 receives a verification response 124 indicating whether application signature 120 is verified. If application signature 120 is not verified, SSO application 104 may execute a predefined action, such as closing application 112 or taking another action.

Turning to FIG. 1B, if user 110 verifies application signature 120, SSO application 104 adds application identifying information 130 for application 112, the user credentials for application 112 (credentials 132) and signature 120 as a verified signature 134 to secure login store 106. Further, SSO application 104, according to one embodiment, provides the login credentials 132 to application 112 for login. In one embodiment, SSO application 104 injects credentials 132 into the appropriate fields of application screen 114, which will be known from when it analyzed application screen 114 to identify it as a login screen.

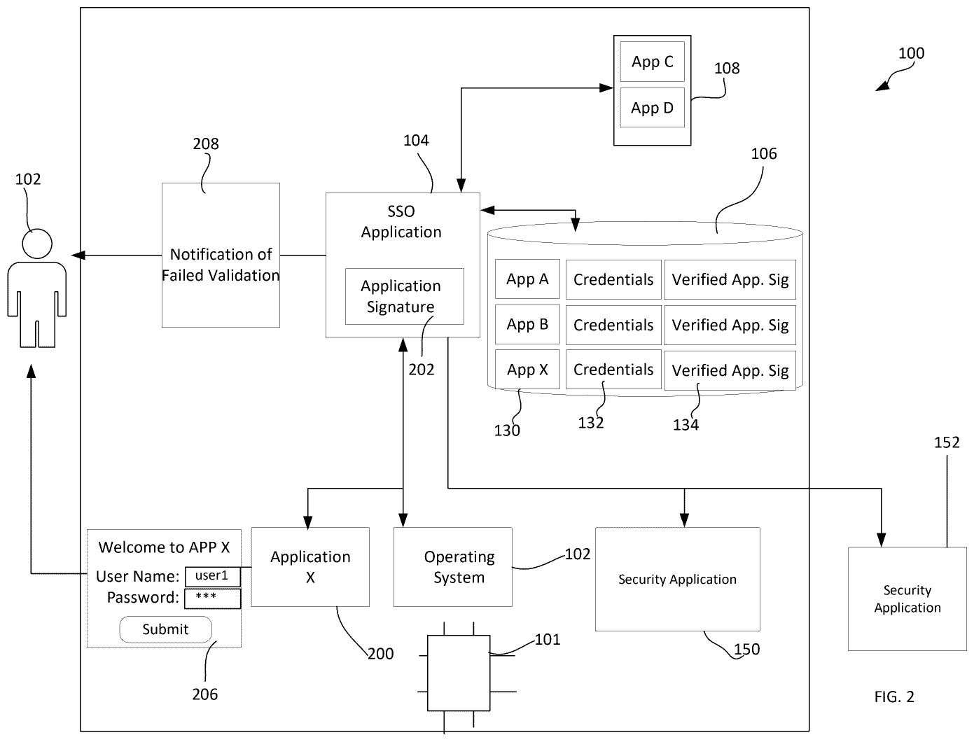

With reference to FIG. 2, SSO application 104 detects newly opened application 200. Here, the identifying information of application 200 identifies application 200 as Application X (e.g., appx. exe). SSO application 104 determines that there is a verified signature for application 200 in secure login store 106 and fetches associated credentials 132 and verified application signature 134 for Application X. SSO application 104 generates application signature 202 for application 200 in the same manner that it generated application signature 120 (now verified application signature 134) for application 112.

SSO application 104 attempts to validate signature 202 of newly opened application 200 by comparing application signature 202 to verified application signature 134. If the signatures match, this indicates that newly opened application 200 is a valid application (e.g., another instance of application 112). Accordingly, SSO application provides the login credentials 132 associated with the verified application signature 134 to newly opened application 200 for login. According to one embodiment, SSO application 104 injects credentials 132 into the appropriate fields of login screen 206. The mapping of credentials to the fields of screen 206 are known from when SSO application 104 analyzed application screen 114.

If application signature 202 does not match verified application signature 134, this may indicate that newly opened application 200 is a malicious copycat of application 112 or that application 112 has been tampered with. SSO application 104 generates a notification 208 to user 110 that validation failed and the user 110 may take remedial action if desired. In addition, or in the alternative, SSO application 104 sends a validation failure notification to a local security application 150 or a remote secure application 152 to take remedial action. For example, in one embodiment, SSO application 104 sends a validation failure notification with application details of application 200 to a remote security application 152, which may be a security operations application, and remote security application 152 prompts local security application 150, which may be an endpoint agent, to remove application 200 from computer system 100.

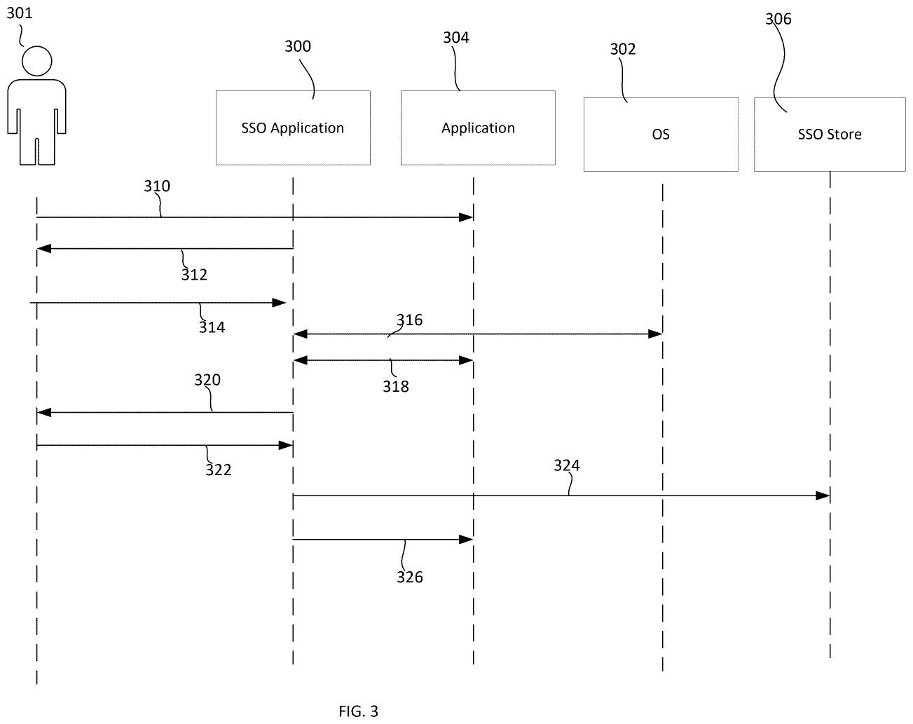

FIG. 3 illustrates one embodiment of a flow between components of a computer system including an SSO application 300, an operating system 302, an application 304, and a secure login store 306. According to one embodiment, SSO application 300, operating system 302, and application 304 are executed on the same processor.

SSO application 300 monitors the computer system for user 301 opening applications, such as application 304. At flow 310, user 301 attempts to open application 304 and SSO application 300 detects user 301 opening application 304. SSO application 300 determines that application 304 is requesting login and generates a prompt 312 requesting whether SSO should be enabled for the application. SSO application 300 receives a response 314 that indicates that SSO should be enabled for application 304. In some embodiments, response 314 includes the user credentials for application 304. In other embodiments, SSO application 300 collects the credentials at another point in the overall flow. At flow 316, SSO application 300 interacts with operating system 302 to collect data for inclusion in an application signature. In addition, or in the alternative, SSO application 300 fetches signature details from application 304 (indicated at flow 318).

SSO application 300 displays a signature verification request 320 to user 301. SSO application 300 receives a signature verification response 322 indicating that the signature is verified. SSO application 300, at flow 324, stores the credentials and application signature for application 304 in secure login store 306. SSO application 300 further provides the user credentials to application 304 (flow 326).

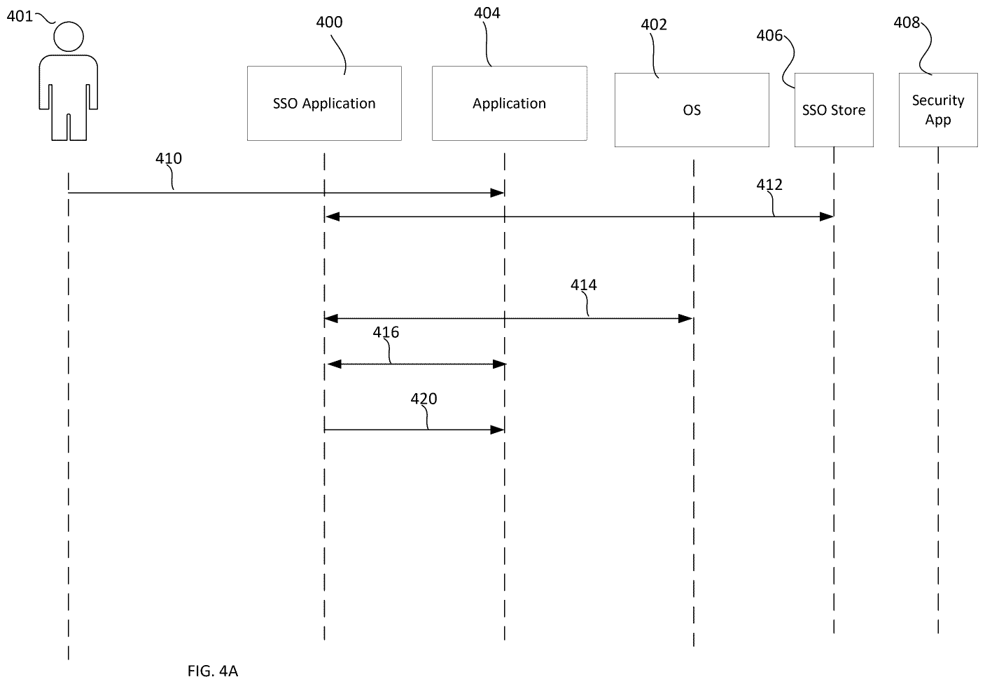

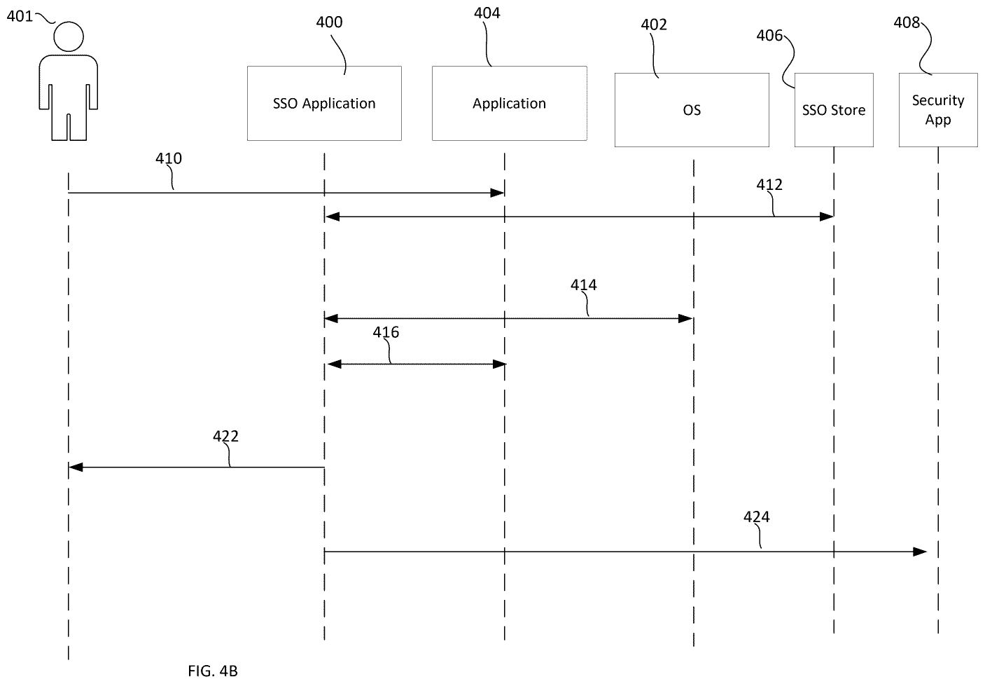

FIG. 4A and FIG. 4B illustrate embodiments of a flow between components of one embodiment of a computer system including an SSO application 400, an operating system 402, an application 404, a secure login store 406, and a security application 408. According to one embodiment, SSO application 400, operating system 402, and application 404 are executed on the same processor. Security application 408 may be a local or remote security application.

SSO application 400 monitors the computer system for user 401 opening applications, such as application 404. At flow 410, user 401 attempts to open application 404 and SSO application 400 detects the newly opened application 404. SSO application 400 fetches a verified signature and credentials associated with identifying information of newly opened application 404 from secure login store 406 (flow 412). At flow 414, SSO application 400 interacts with operating system 402 to collect data for inclusion in an application signature for newly opened application 404. In addition, or in the alternative, SSO application 400 fetches signature details from application 404 (indicated at flow 416).

SSO application 400 compares the signature generated for application 404 to the signature fetched from secure login store 406. If the signatures match, SSO application 400 provides the login credentials associated with the verified application signature to newly opened application 404 for login (flow 420). According to one embodiment, SSO application 400 injects the credentials fetched from secure login store 406 into the fields of a login screen of application 404.

Turning to FIG. 4B, if the signatures do not match, SSO application declines to authorize log in to newly opened application 404 and provides a notification 422 to user 401 indicating that the signature of application 404 could not be validated. SSO application 400 also sends a validation failure notification 424 to security application 408, which may take remedial action based on notification 424, such as removing application 404.

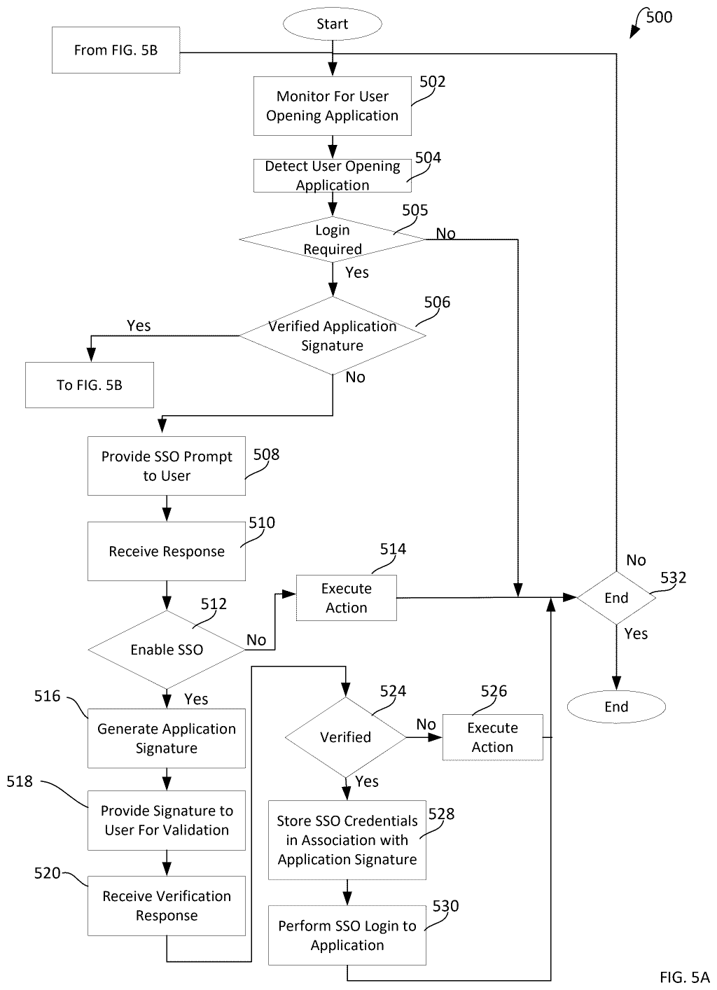

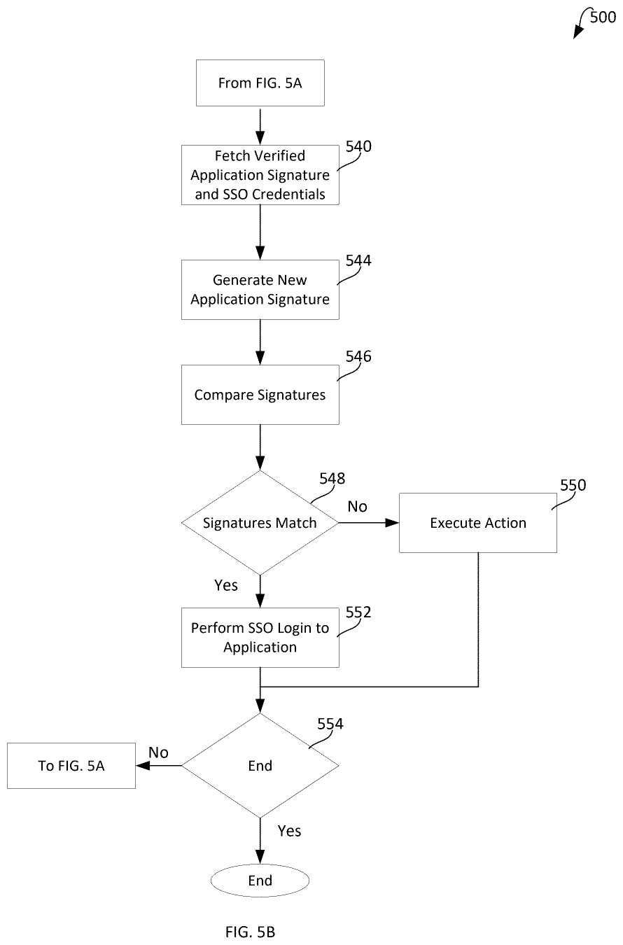

FIG. 5A and FIG. 5B are a flowchart of one embodiment of a secure login authentication process 500. Secure login authentication process 500 may be embodied, in some embodiments, as computer executable instructions stored on a non-transitory, computer-readable medium. Secure login authentication process 500 may be implemented, in some embodiments, by an SSO application, such as SSO application 104.

At step 502, a computer system is monitored for the opening of an application. Various techniques may be used to monitor a computer system for the opening of an application. Example monitoring techniques include, but are not limited to, polling the operating system for new processes, polling the operating system for running processes and comparing the list of running processes returned to a prior list of running processes to identify newly started processes, setting system hooks to listen for events that indicate process creation, such as window creation events, or using event tracing features of the operating system to monitor for when a new process is created. Thus, at step 504, the opening of an application is detected.

At step 505, a determination is made whether the application requires login. In one embodiment, for example, a knowledgebase of applications that require login may be consulted to determine if the application is one that requires login. In another embodiment, the user interface of the application is analyzed to determine if the user interface is requesting credentials. For example, the user interface of the application may be analyzed to determine if it includes fields. Any suitable technique for recognizing requests for credentials, such as a username, password, PIN, etc. can be used. By way of example, but not limitation, analyzing the user interface of the application may include taking screenshots of the user interface, recording a video stream of the user interface, or using system APIs to capture the graphics output from the application. Data element recognition (e.g., optical character and object recognition) can be applied to the user interface to extract text and objects from the user interface and the extracted data elements analyzed to identify if certain labels (e.g., username, password, PIN) appear in proximity to text input boxes.

If the application does not require login control can pass to step 532. If the application requires login, control passes to step 506. At step 506, a secure login store is checked for a valid application signature for the newly opened application. In one embodiment, applications are categorized by application identifying information, such as binary name (e.g., *.exe), and the secure login store is checked to determine if it includes a verified application signature associated with the application identifying information of the newly opened application. If the secure login store includes a verified signature for the application, control passes to FIG. 5B. If the secure login store does not include a verified signature for the opened application, control passes to step 508.

At step 508, an SSO prompt is provided to the user. The SSO prompt may, for example, include a control to allow the user to enable SSO for the newly opened application. In some embodiments, the SSO prompt includes controls to allow the user to enter the credentials requested by the application.

At step 510, a response to the SSO prompt is received and a determination is made whether to enable SSO based on the response (step 512). If the response indicates not to enable SSO for the application, a predefined action may be executed (step 514). In one embodiment, for example, the user's credentials are passed to the application. In another embodiment, the user is blocked from accessing the application. Control passes to step 532.

If SSO is to be enabled for the application, an application signature for the application is generated (step 516). Preferably, the application signature comprises a combination of data associated with aspects of the application that are difficult to replicate in a copycat application. According to one embodiment, the application signature includes one or more of the following: a digital certificate of the application, a checksum of the application, dependent dynamic library (e.g., DLL) extracted information, unique id of the application (e.g., application GUID), application-specific list of dynamic libraries loaded, or trace of API calls made by the application upon launch.

The application signature is provided to the user for verification (step 518). In one embodiment, an interface of one or more pages is provided to the user that displays the signature and includes a tool to allow the user to verify the signature. If the user's credentials have not yet been collected, the interface may include controls to collect user credentials.

A verification response is received indicating if the signature is verified (step 520). A determination can thus be made of whether the signature is verified (step 524). If the signature is not verified, control can pass to step 526 where a predefined action can be executed. In one embodiment, for example, the user's credentials are used to complete the login. In another embodiment, the user is blocked from logging in to the application.

If the application signature is verified, the user's credentials and signature are stored in association with the application identifying information in the secure login store (step 528). At step 530, login is completed using the credentials (step 530). For example, the credentials are injected into the credentials fields detected in the application screen. Control passes to step 532. If an ending condition is not detected, control returns to step 502. If an ending condition is detected, secure login authentication process 500 ends.

Returning to step 506, If the secure login store includes a verified signature for the application, control passes to step 540 of FIG. 5B. At step 540, the verified signature and credentials associated with the signature are fetched. At step 544, a new application signature is generated for the newly opened application by collecting the same data for the newly opened application as was collected when the verified signature was generated.

At step 546, the new application signature is compared to the verified application signature and, at step 548, determination is made as to whether the signature generated at step 544 is a valid signature. If the signatures do not match, a predefined action may be executed (step 550). According to one embodiment, the predefined action includes one or more of the following: declining the authorization for SSO login operation to the newly opened application, automatically terminating the application, sending application information of the application to a local security application, sending application information of the application to a remote security application, providing a notification to the user that the signature could not validated. Control passes to step 554. If an ending condition is not detected, control returns to step 502 (FIG. 5A). If an ending condition is detected, secure login authentication process 500 ends.

Returning to step 548, if the signature generated at step 544 matches the verified signature, control passes to step 552 and SSO login to the newly opened application can be performed. For example, the credentials associated with the application are provided to the newly opened application for login.

FIG. 5A and FIG. 5B are merely illustrative and the disclosed subject matter is not limited to the ordering or number of steps illustrated. Embodiments may implement additional steps or alternative steps, omit steps, or repeat steps.

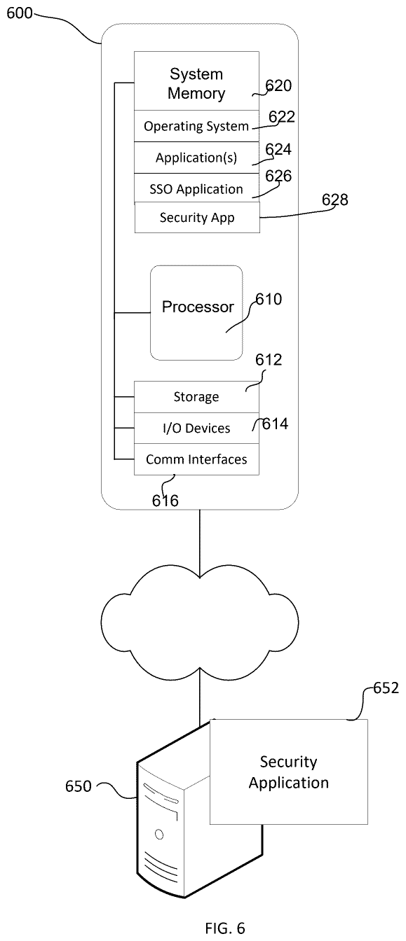

FIG. 6 illustrates one embodiment of a computer system 600. Computer system 100 includes a processor 610 and memory 620. Depending on the exact configuration and type of computing device, memory 620 (storing, among other things, executable instructions) may be volatile (such as RAM), non-volatile (such as ROM, flash memory, etc.), or some combination of the two. Further, computer system 600 may also include storage devices 612, such as, but not limited to, solid state storage. Similarly, computer system 600 may also have input device(s) and output device (I/O devices 614) such as keyboard, mouse, pen, voice input, touch screen, speakers. Client computing device further includes communications interfaces 616, such as a cellular interface, a Wi-Fi interface, or other interfaces.

Computer system 600 includes at least some form of non-transitory computer-readable media. The non-transitory computer-readable readable media can be any available media that can be accessed by processor 610 or other devices comprising the operating environment. By way of example, non-transitory computer-readable media may comprise computer storage media such as volatile memory, nonvolatile memory, removable storage, or non-removable storage for storage of information such as computer readable-instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

As stated above, a number of program modules and data files may be stored in system memory 620. While executing on processor 610, program modules (e.g., applications, Input/Output (I/O) management, and other utilities) may perform processes including, but not limited to, one or more of the stages of the operational methods described with respect to SSO application 104, SSO application 300, SSO application 400. In one embodiment, system memory 620 stores an operating system 622, an SSO application 626, applications 624, and a security application 628. SSO application 626 may be one embodiment of SSO application 104, SSO application 300, or SSO application 400. In some embodiments, SSO application 626 may notify a remote security application 652 running on a server 650 of an application signature validation failure.

Some embodiments may be practiced in an electrical circuit comprising discrete electronic elements, packaged or integrated electronic chips containing logic gates, a circuit utilizing a microprocessor, or chip single chip containing electronic elements or microprocessors. For example, examples of computer system 600 may be practiced via a system-on-a-chip (SOC) where each or many of the components of computer system 600 may be integrated onto a single integrated circuit. Such an SOC device may include processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment on the single integrated circuit (chip).

The different aspects described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

Portions of the methods described herein may be implemented in suitable software code that may reside within RAM, ROM, a hard drive, or other non-transitory storage medium. Alternatively, the instructions may be stored as software code elements on a data storage array, magnetic tape, floppy diskette, optical storage device, or other appropriate data processing system readable medium or storage device.

Although the invention has been described with respect to specific embodiments thereof, these embodiments are merely illustrative, and not restrictive of the invention as a whole. Rather, the description is intended to describe illustrative embodiments, features, and functions in order to provide a person of ordinary skill in the art context to understand the invention without limiting the invention to any particularly described embodiment, feature, or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods, or programs of embodiments of the invention described herein. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

Particular routines can be executed on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps, and operations described herein can be performed in hardware, software, firmware, or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features, and functions in order to provide a person of ordinary skill in the art context to understand the invention without limiting the invention to any particularly described embodiment, feature, or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A computer-implemented method for single sign-on, the method comprising:
detecting that a first application has been opened;
generating for the first application, a first application signature;
prompting a user to verify the first application signature;
based on the user verifying the first application signature, storing the first application signature as a verified application signature in association with login credentials for the user; and
programmatically providing the login credentials to the first application for login.

2. The computer-implemented method of claim 1, wherein the first application signature comprises at least one of the following:
a digital certificate of the first application;
a checksum of the first application;
a tracing for dependent dynamic link libraries of the first application;
a registry setting for the first application, the registry setting comprising a globally unique identifier for the first application;
an application specific list of dynamic link libraries loaded by the first application; or
a list of application programming interface calls made by the first application.

3. The computer-implemented method of claim 1, wherein the first application signature comprises:
a digital certificate of the first application;
a checksum of the first application;
a tracing for dependent dynamic link libraries of the first application;
a registry setting for the first application, the registry setting comprising a globally unique identifier for the first application;
an application specific list of dynamic link libraries loaded by the first application; and
a list of application programming interface calls made by the first application.

4. The computer-implemented method of claim 1, further comprising:
presenting the user with an interface that includes a first control to allow the user to verify the first application signature; and
receiving a verification of the first application signature based on a user interaction with the first control.

5. The computer-implemented method of claim 4, wherein the interface comprises a second control, the second control adapted to allow the user to enter the login credentials and wherein the method further comprises:
receiving the login credentials based on a user interaction with the second control.

6. The computer-implemented method of claim 1, further comprising:
detecting a newly opened application;
generating an application signature for the newly opened application;
comparing the application signature for the newly opened application to the verified application signature to determine if the application signature for the newly opened application matches the verified application signature; and
based on a determination that the application signature for the newly opened application matches the verified application signature, programmatically providing the login credentials associated with the verified application signature to the newly opened application for login.

7. The computer-implemented method of claim 1, further comprising:
detecting a newly opened application;
generating an application signature for the newly opened application;
comparing the application signature for the newly opened application to the verified application signature to determine if the application signature for the newly opened application matches the verified application signature; and
based on a determination that the application signature for the newly opened application does not match the verified application signature, declining authorization to log in to the newly opened application.

8. The computer-implemented method of claim 7, further comprising sending an alert to the user indicating that the application signature of the newly opened application does not match the verified application signature.

9. A non-transitory, computer-readable medium storing thereon a set of computer-executable instructions for single sign-on, the set of computer-executable instructions comprising instructions for:
detecting a first application that has been opened;
generating a first application signature for the first application;
prompting a user to verify the first application signature;
based on the user verifying the first application signature, storing the first application signature as a verified application signature in association with login credentials for the user; and
programmatically providing the login credentials to the first application for login.

10. The non-transitory, computer-readable medium of claim 9, wherein the first application signature comprises at least of the following:
a digital certificate of the first application;
a checksum of the first application;
a tracing for dependent dynamic link libraries of the first application;
a registry setting for the first application, the registry setting comprising a globally unique identifier for the first application;
an application specific list of dynamic link libraries loaded by the first application; or
a list of application programming interface calls made by the first application.

11. The non-transitory, computer-readable medium of claim 9, wherein the first application signature comprises:
a digital certificate of the first application;
a checksum of the first application;
a tracing for dependent dynamic link libraries of the first application;
a registry setting for the first application, the registry setting comprising a globally unique identifier for the first application;
an application specific list of dynamic link libraries loaded by the first application; and
a list of application programming interface calls made by the first application.

12. The non-transitory, computer-readable medium of claim 9, wherein the set of computer-executable instructions further comprises instructions for:
presenting the user with an interface that includes a first control to allow the user to verify the first application signature; and
receiving a verification of the first application signature based on a user interaction with the first control.

13. The non-transitory, computer-readable medium of claim 12, wherein the interface comprises a second control, the second control adapted to allow the user to enter the login credentials and wherein the set of computer-executable instructions further comprises instructions for:
receiving the login credentials based on a user interaction with the second control.

14. The non-transitory, computer-readable medium of claim 9, wherein the set of computer-executable instructions further comprises instructions for:
detecting a newly opened application;
generating an application signature for the newly opened application;
comparing the application signature for the newly opened application to the verified application signature to determine if the application signature for the newly opened application matches the verified application signature; and
based on a determination that the application signature for the newly opened application matches the verified application signature, programmatically providing the login credentials associated with the verified application signature to the newly opened application for login.

15. The non-transitory, computer-readable medium of claim 14, wherein the set of computer-executable instructions further comprises instructions for:
declining authorization to log in to the newly opened application based on a determination that the application signature of the newly opened application does not match the verified application signature.

16. The non-transitory, computer-readable medium of claim 15, wherein the set of computer-executable instructions further comprises instructions for:
sending an alert to the user indicating that the signature of the newly opened application does not match the verified application signature.

17. A computer system with single sign-on capability, comprising:
a processor;
a memory storing a plurality of applications, the plurality of application comprising a single sign-on application, wherein the single sign-on application is executable to run as a background process, wherein the single sign-on application comprises instructions for:
detecting a first opening of a first application by a user;
generating a first application signature for the first application;
prompting the user to verify the first application signature;
based on the user verifying the first application signature, storing the first application signature as a verified application signature in association with login credentials for the user; and
programmatically providing the login credentials associated with the verified application signature to the first application for login.

18. The computer system of claim 17, wherein the first application signature comprises at least one of the following:
a digital certificate of the first application;
a checksum of the first application;
a tracing for dependent dynamic link libraries of the first application;
a registry setting for the first application, the registry setting comprising a globally unique identifier for the first application;
an application specific list of dynamic link libraries loaded by the first application; or
a list of application programming interface calls made by the first application.

19. The computer system of claim 17, wherein the single sign-on application comprises instructions for:
detecting a newly opened application;
generating an application signature for the newly opened application;
comparing the application signature for the newly opened application to the verified application signature to determine if the application signature for the newly opened application matches the verified application signature; and
based on a determination that the application signature for the newly opened application matches the verified application signature, programmatically providing the login credentials associated with the verified application signature to the newly opened application for login.

20. The computer system of claim 19, wherein the single sign-on application comprises instructions for:
declining authorization to log in to the newly opened application based on a determination that the application signature for the newly opened application does not match the verified application signature.
